(19) United States
(12) Patent Application Publication
(10) Pub. No.: US 2004/0013447 A1
(43) Pub. Date: Jan. 22, 2004

(54) Consumable product unit, consumable product replacement sensing system and method thereof

(75) Inventor: Min-Seon Kim, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/619,214

(22) Filed: Jul. 15, 2003

(30) Foreign Application Priority Data
Jul. 15, 2002 (KR) 2002-41368
Jun. 30, 2003 (KR) 2003-43998

(51) Int. Cl. G03G 21/18

(52) U.S. Cl. 399/112

(57) ABSTRACT

A consumable product unit, a consumable product replacement sensing apparatus and a method thereof are provided. First through third connection terminals of the consumable product unit are respectively and electrically connected to fourth through sixth connection terminals of the consumable product replacement sensing apparatus. A new product determining signal generating unit generates a signal corresponding to an effective resistance value of the consumable product unit connected to the consumable product replacement sensing apparatus through the fourth and fifth connection terminals. If the consumable product unit is new determined to be, an over-current supplying unit supplies an over-current to disconnect a fusible resistor of the consumable product unit and the new product determining signal generating unit generates the signal corresponding to an effective resistance value of one determining element of the consumable product unit. An engine control unit determines whether the consumable product unit is usable.

### CROSS-REFERENCE TO RELATED APPLICATIONS

This application claims the benefit of Korean Application No. 2002-41368, filed Jul. 15, 2002 and Korean Application No. 2003-43998, filed Jun. 30, 2003, in the Korean Intellectual Property Office, the disclosures of which are incorporated herein by reference.

### BACKGROUND OF THE INVENTION

1. Field of the Invention

The present invention relates to a consumable product unit, a consumable product replacement sensing system and a method thereof, and more particularly, to a consumable product unit, a consumable product replacement sensing system and a method thereof, for recognizing whether or not a new consumable product unit is mounted in a system, as a replacement, and determining whether or not the new consumable product unit is one to use in the system, both of which by using a single circuit.

2. Description of the Related Art

Generally, a photocopier, a printer, a facsimile machine, and a multi-function machine having multi-functions of the photocopier, the printer, and the facsimile machine are types of electrophotograph printing apparatuses. Such a printing apparatus forms an image such that the printing apparatus provides a solid type developer, such as a toner, to a photosensitive medium where an electrostatic latent image forms or the printing apparatus jets a liquid type developer onto the photosensitive medium, and prints an image corresponding to the electrostatic latent image on a paper passing through rollers rotating and in contact with the photosensitive medium.

Consumable products such as a developer or a photosensitive belt of the printing apparatus are consumed or wear out as a result of a continuous use thereof. Accordingly, the consumable products, such as the developer and photosensitive belt are required to be replaced with new ones at proper times. For a replacement of the consumable products, a conventional printing apparatus comprises separate determination circuits to determine whether a newly replaced consumable product is a new consumable product or a used consumable product and to determine whether or not the consumable product is usable in the printing apparatus.

Therefore, the conventional printing apparatus requires an intermediate path circuit having a plurality of ports to connect with the respective determination circuits to an engine control unit. Since the intermediate path circuit is fabricated by an application-specific integrated circuit (ASIC) to have the plurality of ports, a problem of increased fabrication costs exists.

### SUMMARY OF THE INVENTION

The present invention solves the above problem in the conventional art. Accordingly, an aspect is to provide a consumable product unit, a consumable product replacement sensing system and a method thereof to determine whether a consumable product unit is mounted in a system, as a replacement, and whether the consumable product unit is usable in the system, both of which are determined by using a single circuit.

Additional aspects and/or advantages of the invention will be set forth in part in the description which follows and, in part, will be obvious from the description, or may be learned by practice of the invention.

The above and/or other aspects are achieved by providing a consumable product replacement sensing system including a consumable product unit to determine whether a consumable product is new and determine a type of the consumable product and a consumable product replacement sensing apparatus, where the consumable product unit is mounted, to determine whether the consumable product is new and to determine the type of the consumable product.

Further, the consumable product unit comprises a first determination element determining whether a replaced consumable product is a new consumable product, a second determination element determining a type of the replaced consumable product, a first connection terminal connected to a first end of the first determination element, a second connection terminal connected to a first end of the second determination element, and a third connection terminal commonly connected to second ends of the first and the second determination elements.

Further, the first determination element is a first fusible resistor having a predetermined first resistance value and melts to disconnect the first and third connection terminals when an over-current is supplied.

Further, the second determination element is a second resistor having a predetermined second resistance value. The second resistance value is higher than the first resistance value and varies according to a manufacturer of the consumable product.

Further, the consumable product replacement sensing apparatus comprises fourth through sixth connection terminals electrically and respectively connected to the first through the third connection terminals, a new product determining signal generating unit generating a level of electrical potential corresponding to at least one of the first and the second determination elements connected to the consumable product replacement sensing apparatus through the fourth and the fifth connection terminals to determine whether the consumable product unit is a new consumable product, an over-current supplying unit intermitting a current-flow path continuing from the fourth connection terminal through the first determination element and the sixth connection terminal by supplying an over-current to disconnect the first determination element, (i.e., disconnect the current-flow path between the first and third connection terminals) and an engine control unit controlling the over-current supplying unit to disconnect the first determination element if the consumable product is determined to be new by the level of electrical potential generated at the new product determining signal generating unit, the engine control unit determining a type of the consumable product by the level of electrical potential corresponding to the second determination element.

The engine control unit may determine that the consumable product is a new consumable product if the level of electrical potential outputted from the new product determining signal generating unit is a first electrical potential level corresponding to the first and the second determination elements, and may determine that the consumable product is a used consumable product if the level of electrical potential outputted from the new product determining signal generating unit is a second electrical potential level corresponding to the second determination element. The first electrical potential level may be lower than a reference level, and the second electrical potential level may exceed the reference value.

Further, the level of electrical potential to determine whether the consumable product unit is new and the level of electrical potential corresponding to the second determination element are inputted from the new product determining signal generating unit to the engine control unit through a shared port.

More specifically, the new product determining signal generating unit comprises a first power source, a third resistor having a first end connected to the first power source and a second end connected to the engine control unit and the fifth connection terminal, and a diode disposed between the fourth and fifth connection terminals to prevent an electric current of the fourth connection terminal from flowing into the fifth connection terminal.

Further, the over-current supplying unit comprises a second power source, and a switching element to connect or to disconnect the second power source to or from the fifth connection terminal according to a control signal of the engine control unit.

The consumable product may be a cartridge containing one or more predetermined color developers, the consumable product unit provided with the consumable product may be a developing device that develops an image by using the one or more color developers supplied from the consumable product, and the consumable product replacement sensing, apparatus may be provided in an image forming apparatus that forms the image developed by the developing device on a paper.

Further, the above and/or other aspects are achieved by providing a consumable product replacement sensing method comprising mounting a consumable product unit in a consumable product replacement sensing apparatus, the consumable product unit determining whether a consumable product is a new consumable product and determining a manufacturer of the consumable product, when the consumable product unit is mounted, and determining whether the consumable product is a consumable product to use in the consumable product replacement sensing apparatus.

More specifically, the determining of whether the consumable product is the new consumable product comprises respectively and electrically connecting first through third connection terminals to fourth through sixth connection terminals provided in the consumable product replacement sensing apparatus, wherein the first connection terminal is connected to a first end of a first determination element to determine whether the consumable product is the new consumable product, the second connection terminal is connected to a first end of a second determination element to determine whether the consumable product is usable, and the third connection terminal is commonly connected to second ends of the first and the second determination elements; generating a level of electrical potential corresponding to at least one of the first and second determination elements connected to the consumable product replacement sensing apparatus through the fourth and fifth connection terminals; determining whether the consumable product is the new consumable product by the level of electrical potential; supplying an over-current to the first determination element to disconnect the first determination element when the consumable product is determined to be new; and determining whether the consumable product is usable by the level of electrical potential corresponding to the second determination element. The first through the third connection terminals are provided in the consumable product unit.

The determining of whether the consumable product is the new consumable product determines that the consumable product is the new consumable product if the level of electrical potential is a first electrical potential level corresponding to the first determination element, and determines that the consumable product is a used consumable product if the level of electrical potential is a second electrical potential level corresponding to the second determination element. The first electrical potential level is lower than a reference level.

### BRIEF DESCRIPTION OF THE DRAWINGS

These and/or other aspects and advantages of the invention will become apparent and more readily appreciated from the following description of the preferred embodiment, taken in conjunction with the accompanying drawings in which:

FIG. 1 is a circuit diagram showing a consumable product replacement sensing system according to an embodiment of the present invention; and

FIG. 2 is a flow chart showing a method of sensing a consumable product replacement according to the apparatus of FIG. 1.

### DETAILED DESCRIPTION OF THE PREFERRED EMBODIMENT

Reference will now be made in detail to the present preferred embodiment of the present invention, examples of which are illustrated in the accompanying drawings, wherein like reference numerals refer to the like elements throughout. The embodiment is described below in order to explain the present invention by referring to the figures.

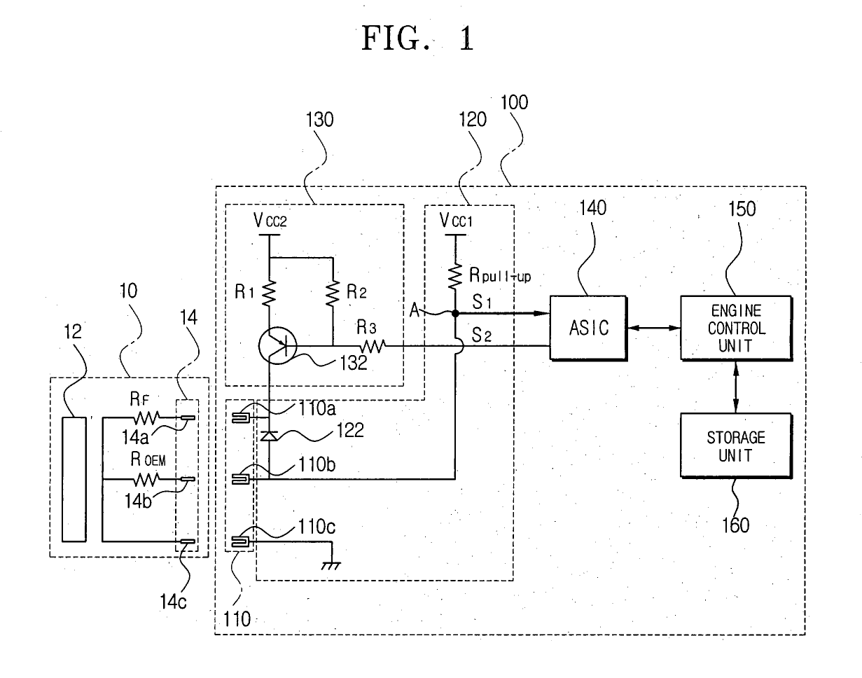

FIG. 1 is a circuit diagram showing a consumable product replacement sensing system according to an embodiment of the present invention.

Referring to FIG. 1, a consumable product replacement sensing system comprises a consumable product unit 10 and a consumable product replacement sensing apparatus 100.

The consumable product unit 10 is replaceably mounted on the consumable product replacement sensing apparatus 100 and is replaced with a new consumable product unit when a consumable product 12 provided in the consumable product unit 10 is completely consumed. By way of example, this embodiment uses a cartridge containing one or more color developers as the consumable product 12, and a developing device as the consumable product unit 10, which develops an image by utilizing the one or more color developers supplied from the consumable product 12. The consumable product replacement sensing apparatus 100 determines whether or not the consumable product unit 10 and/or the consumable product 12 are new and usable.

That is, the consumable product 12 is, for example, a toner, ink, a developer or a photosensitive belt, which is consumed as a result of a continuous use thereof, and the consumable product unit 10 is a developing device including a developing roller (not shown) and a developer supplying roller (not shown). The consumable product replacement sensing apparatus 100 is mountable in an image forming apparatus (not shown) to form an image developed by the consumable product unit 10 on a paper.

The consumable product unit 10 has the consumable product 12, a first determination element R_{F}, a second determination element R_{OEM}, and a first connection terminal unit 14.

The consumable product 12, which is a cartridge in this embodiment by way of example, contains a yellow developer, a magenta developer, a cyan developer and a black developer. The consumable product 12 may have additional color developers. If the image forming apparatus (not shown) employing the consumable product replacement sensing apparatus 100 is only a one-color device (i.e., is mono type), the consumable product 12 may contain only the black developer.

The first determination element R_{F} determines whether or not replacement consumable product unit 10 and/or a replacement consumable product 12 included therewith are new. The first determination element R_{F} uses a fusible resistor having a predetermined first resistance value (e.g. in a range of about 50 Ω). The fusible resistor melts to disconnect from at least one of first and third connection terminals 14a and 14c when an over-current condition causes an over-current to flow therein.

The second determination element R_{OEM} determines whether or not the consumable product unit 10 and/or the consumable product 12 included therewith are useable in the consumable product replacement sensing apparatus 100. The second determination element R_{OEM} is an OEM resistor to recognize/determine an attachment of an Original Equipment Manufacturer (hereinafter, referred to as “OEM”).

The second determination element R_{OEM}, which has a second resistance value differing from that of the first resistance value and varies according to a manufacturer and a type of the consumable product 12. Accordingly, the consumable product replacement sensing apparatus 100 determines whether or not the consumable product unit 10 and/or the consumable product 12 included therewith are useable in the consumable product replacement sensing apparatus 100, based on a resistance value of the second determination element R_{OEM}. The second resistance value may be in a range of approximately 7 kΩ and varies according to the manufacturer and the type of the consumable product 12.

The consumable product unit 10 is provided with the first connection terminal unit 14 disposed at an end of the consumable product unit 10 to electrically connect the consumable product unit 10 and the consumable product replacement sensing apparatus 100. The first connection terminal unit 14 has a first connection terminal 14a connected to a first end of the first determination element R_{F}, a second connection terminal 14b connected to a first end of the second determination element R_{OEM} and a third connection terminal 14c commonly connected to second ends of the first and second determination elements R_{F} and R_{OEM}.

Further, the consumable product replacement sensing apparatus 100 provided in the image forming apparatus (not shown) comprises a second connection terminal unit 110, a new product determining signal generating unit 120, an over-current supplying unit 130, an ASIC 140, an engine control unit 150 and a storage unit 160.

The consumable product replacement sensing apparatus 100 determines whether or not the replaced/mounted consumable product unit 10 and/or the replaced/mounted consumable product 12 included therewith are new and determines whether or not the replaced/mounted consumable product unit 10 and/or the replaced mounted consumable product 12 included therewith are useable in the consumable product replacement sensing apparatus 100. Since the determining operations of the consumable product unit 10 are performed in the same manner as that of consumable product 12, hereinafter, descriptions are provided only with regard to the consumable product unit 10 for convenience of explanation, but would additionally apply to the consumable product 10.

The second terminal unit 110 has forth through sixth connection terminals 110a, 110b and 110c. The fourth through the sixth connection terminals 110a, 110b and 110c are respectively and electrically connected with the first through the third connection terminals 14a, 14b and 14c.

The new product determining signal generating unit 120 has a first power source V_{CC1}, a pull-up resistor Rₚᵤₗₗ₋ᵤₚ and a diode 122.

The pull-up resistor Rₚᵤₗₗ₋ᵤₚ has a first end serially connected to the first power source V_{CC1} and a second end connected with the ASIC and the fifth connection terminal 110b. The diode 122 is disposed between the fourth connection terminal 110a and the fifth connection terminal 110b to prevent an electric current of the fourth connection terminal 110a from flowing to the fifth connection terminal 110b.

When the first connection terminal unit 14 of the consumable product unit 10 is connected to the second connection terminal unit 110 of the consumable product replacement sensing apparatus 100 so that the consumable product unit 10 is mounted on the consumable product replacement sensing apparatus 100, the new product determining signal generating unit 120 generates a level of electrical potential S1 that corresponds to an effective resistance value of the consumable product unit 10 connected to the consumable product replacement sensing apparatus 100 through the fourth and the fifth connection terminals 110a and 110b.

That is, the new product determining signal generating unit 120 generates a level of electrical potential S1 that corresponds to at least one of the first and the second determination elements R_{F} and R_{OEM}. The engine control unit 150 determines whether the consumable product unit 10 and/or the consumable product 12 included therewith are new, based on the level of electrical potential S1.

More specifically, when the consumable product unit 10 is mounted on the consumable product replacement sensing apparatus 100, the first power source V_{CC1} supplies a predetermined electric potential to the pull-up resistor Rₚᵤₗₗ₋ᵤₚ. If the consumable product unit 10 is the new consumable product unit, the level of electrical potential S1 at a node A has a ‘low’ value due to a current path that forms among the pull-up resistor Rₚᵤₗₗ₋ᵤₚ, the node A and the sixth connection terminal 110c, which is grounded.

That is, if the consumable product unit 10 is the new consumable product unit, the effective resistance value has a parallel composite resistance value of the first and second determination elements R_{F} and R_{OEM}. Accordingly, the effective resistance value provides a lowered electrical potential, and the new product determining signal generating unit 120 generates the ‘low’ level of electrical potential S1 at node A. The level of electrical potential S1, which corresponds to the first and the second determination elements R_{F} and R_{OEM}, has a low value if the level of electrical potential S1 is lower than a reference level (e.g., in a range of about 2.4 volt).

If the consumable product unit 10 is a used consumable product unit, the first determination element R_{F} of the fusible resistor melts and is disconnected from at least one of the first and third connection terminals 14a and 14c to produce an open circuit condition such that the effective resistance value has a resistance value of the second determination element R_{OEM} of an OEM resistor. Thus, the effective resistance value provides an increased electrical potential, and the new product determining signal generating unit 120 generates a level of electrical potential that corresponds to the second determination element R_{OEM}. The level of electrical potential S1 at the node A, which corresponds to the second determination element R_{OEM}, has a high value, since the level of electrical potential S1 exceeds the reference level.

The over-current supplying unit 130 has a second power source V_{CC2} and a switching element 132. The over-current supplying unit 130 intermits a current-flowing path continuing from the fourth connection terminal 110a through the first determination element R_{F} to the sixth connection terminal 110c. Further, the over-current supplying unit 130 supplies an over-current to disconnect the first determination element R_{F} from at least one of the first and third connection terminals 14a and 14c.

The second power source V_{CC2} supplies a predetermined electrical potential to a first resistance element R1 serially connected to the second power source V_{CC2} and a second resistance element R2 parallel connected to the first resistance element R1.

The switching element 132 supplies the predetermined voltage supplied from the second power source V_{CC2} to the fourth connection terminal 110a or the switching element 132 blocks the predetermined voltage supplied from the second power source V_{CC2} to the fourth connection terminal 110a according to a control signal (i.e., a level of electrical potential S2) of the engine control unit 150. The switching element 132 uses a PNP type transistor that performs a switching operation by adjusting an electric current flowing between an emitter terminal of the transistor and a collector terminal of the transistor according to a voltage of a base terminal of the transistor.

The ASIC 140 is an intermediate path circuit to output the level of electrical potential S1 inputted from the node A to the engine control unit 150, and is connected to the new product determining signal generating unit 120 through a single shared port, as shown in a thick solid line in FIG. 1. That is, the ASIC 140 is input with the level of electrical potential S1 from the node A through the single shared port.

The engine control unit 150 determines whether or not the consumable product unit 10 is the new consumable product unit and whether or not the consumable product 10 is useable in the consumable product replacement sensing apparatus 100, based on the level of electric potential S1 generated at the new product determining signal generating unit 120. More specifically, the engine control unit 150 determines that the consumable product unit 10 is the new consumable product unit if the level of electric potential S1 initially generated at the new product determining signal generating unit 120 is a first electrical potential level corresponding to the first and the second determination element R_{F} and R_{OEM}. Also, the engine control unit 150 controls the over-current supplying unit 130 to disconnect the first determination element R_{F} from at least one of the first and third connection terminals 14a and 14c. That is, the engine control unit 150 supplies the switching element 132 with the level of electric potential S2, which is lower than a reference level, so that the switching element 132 switches on. When the switching element 132 switches on, the first determination element R_{F} is disconnected by the over-current.

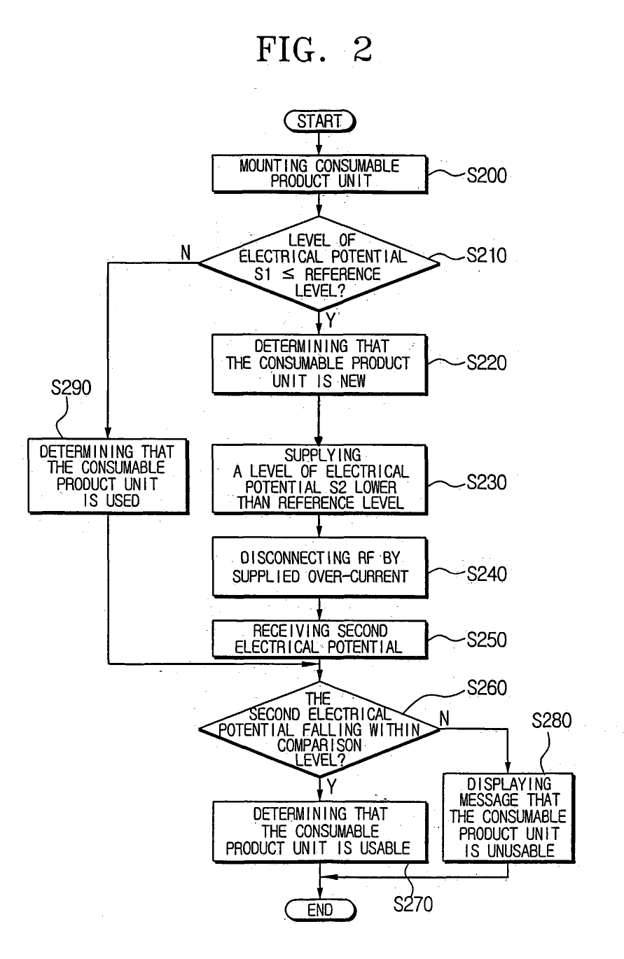

After the disconnection of the first determination element R_{F}, the engine control unit 150 determines whether or not the consumable product unit 10 is usable in the consumable product replacement sensing apparatus 100 by the level of electric potential S1 subsequently generated at the new product determining signal generating unit 120. Descriptions about this will be made in detail later with reference to FIG. 2.

If the level of electric potential S1 initially generated at the new product determining signal generating unit 120 is a second electric potential level corresponding to the second determination element R_{OEM}, the engine control unit 150 determines that the consumable product unit 10, as mounted, is a used consumable product unit.

The first electric potential level is lower than a pre-set reference level, and the second electric potential level exceeds the reference level. The reference levels are pre-set in the storage unit 160 of the consumable product replacement sensing apparatus 100 to determine whether the consumable product unit 10 is the new consumable product unit or the used consumable product unit. In the case that the resistance value of the second determination element R_{OEM} is determined to be within a predetermined range according to the manufacturer, the reference level has a predetermined range according to a predetermined range of the second determination element R_{OEM}

Further, the engine control unit 150 controls general operations of the consumable product replacement sensing apparatus 100 and/or the image forming apparatus (not shown) using the new consumable product replacement sensing apparatus 100 according to the level of electric potential S1. For example, when the engine control unit 150 determines that the consumable product unit 10 is the used consumable product unit by the second potential level inputted from the ASIC 140, the engine control unit 150 displays a message on a panel (not shown) of the image forming apparatus (not shown), indicating that the consumable product unit 10 is unusable.

The storage unit 160 stores the reference level to determine whether the consumable product unit 10 is the new consumable product unit or the used consumable product unit and a comparison level of a predetermined range to determine whether or not the consumable product unit 10 is usable in the consumable product replacement sensing apparatus 100.

Operations of the control engine unit 150 will be described in detail with reference to FIG. 2.

FIG. 2 is a flow chart showing a method of sensing a consumable product replacement.

Referring to FIGS. 1 and 2, the consumable product unit 10 is mounted on the consumable product replacement sensing apparatus 100 used in the image forming apparatus (not shown) at operation S200. The new product determining signal generating unit 120 generates a level of electrical potential S1 corresponding to the effective resistance value of the consumable product unit 10 (i.e., the first electric potential level).

The engine control unit 150 compares the first electric potential level with the reference level pre-set in the storage unit 160 of the consumable product replacement sensing apparatus 100 at operation S210, and determines that the consumable product unit 10 is the new consumable product unit if the first electric potential level is lower than the pre-set reference level at operation S220.

After the operation of S220, the engine control unit 150 supplies the switching element 132 with the level of electric potential S2 lower than the reference level to supply an over-current to the first determination element R_{F} at operation S230. The switching element 132 switches on to allow a flow of the over-current to the first determination element R_{F}, which results in a disconnection of the first determination element R_{F} at operation S240.

After the operation S240, the new product determining signal generating unit 120 outputs a level of electric potential S1 corresponding to the second determination element R_{OEM} (i.e., the second electric potential level) to the ASIC 140. That is, as the first determination element R_{F} is disconnected from at least one of the first and third connection terminals 14a and 14c (i.e., is opened circuited), the effective resistance value of the consumable product unit 10 is determined by only a independent resistance of the second determination element R_{OEM}. The ASIC 140 supplies the second electrical potential level to the engine control unit 150. That is, the second electric potential level, corresponding to the second determination element R_{OEM}, is inputted to the engine control unit 150 through the node A and the ASIC 140. The second electric potential level corresponding to the second determination element R_{OEM} which has a difference resistance value than that of the first determination element R_{F}, and varies according to a manufacturer and a type of the consumable product unit 10.

After the operation S240, the engine control unit 150 receives the second electric potential level corresponding to the second determination element R_{OEM} from the new product determining signal generating unit 120 at operation S250. Then, the engine control unit 150 reads out the comparison level from the storage unit 160 and compares the second electrical potential level with the comparison level at operation S260. The comparison level has a predetermined range to determine whether or not the consumable product 10 is usable in the consumable product replacement sensing apparatus 100 and has different ranges according to the manufacture and the type of the consumable product unit 10.

In the operation S260, if the second electric potential falls within the range of the comparison level, the engine control unit 150 determines that the consumable product unit 10 is usable in the consumable product replacement sensing apparatus 100 at operation S270. If the second electric potential does not fall within the range of the comparison level in the operations S260, the engine control unit 150 determines that the consumable product unit 10 is not usable in the consumable product replacement sensing apparatus 100. Further, the engine control unit 150 displays a message informing that the consumable product unit 10 is not usable in the consumable product replacement sensing apparatus 100 on the panel of the consumable product replacement sensing apparatus 100. An alarm sound may be used instead of or with the message.

Further, if the level of electric potential S1 generated in the operation S220 is higher than the pre-set reference level, the engine control unit 150 determines that the consumable product unit 10 is a used consumable product unit at operation S290. Thus, the level of electrical potential S1 generated in the operation S290 is the second electrical potential level corresponding to the second determination element R_{OEM}. Further, the engine control unit 150 subsequently performs the operations S260-S280 again.

If the second electrical potential level is not received in the operation S250, the first determination element R_{F} is not disconnected from at least one of the first and third connection terminals 14a and 14c. Accordingly, generating the second electrical potential level is delayed until the first determination element R_{F} is disconnected from at least one of the first and third connection terminals 14a and 14c.

The consumable product replacement sensing apparatus 100 as described above is mountable in a system using the consumable product unit 10, for example, in the image forming apparatus. The system is not limited to any one apparatus, thus the system may be used in, for example, a printer, a photocopier and a multi-function machine using a toner.

The consumable product unit 10, the consumable product replacement sensing system and the method thereof, integrate elements to recognize whether the consumable product unit 10 is replaced with the new consumable product unit 10 and to determine whether the consumable product unit 10 is the consumable product unit to be used in the system, into a single circuit, thereby reducing a number of ASIC ports and providing a simplified circuit compared to that of the conventional art. Accordingly, a manufacturing cost of the ASIC is reducible.

The foregoing embodiments and/or advantages are merely exemplary and are not to be constructed as limiting the present invention. The present teaching can be readily applied to other types of apparatuses.

Although an embodiment of the present invention has been shown and described, it would be appreciated by those skilled in the art that changes may be made in this embodiment without departing from the principles and sprit of the invention, the scope of which is defined the claims and their equivalents.

What is claimed is:

1. A consumable product unit comprising:
a first determination element determining whether a replaced consumable product is a new consumable product;
a second determination element determining a type of the consumable product;
a first connection terminal connected to a first end of the first determination element;
a second connection terminal connected to a first end of the second determination element; and
a third connection terminal commonly connected to second ends of the first and second determination elements.

2. The consumable product unit of claim 1, wherein the first determination element is a first resistor having a predetermined first resistance value.

3. The consumable product unit of claim 2, wherein the first resistor is a fusible resistor, which melts to disconnect from at least one of the first and third connection terminals when an over-current is supplied.

4. The consumable product unit of claim 1, wherein the second determination element is a second resistor having a predetermined second resistance value, the second resistance value being higher than the first resistance value.

5. The consumable product unit of claim 4, wherein the second resistance value varies according to a manufacturer of the consumable product.

6. The consumable product unit of claim 4, wherein the second resistance value varies according to a type of the consumable product.

7. The consumable product unit of claim 1, wherein the consumable product is a cartridge having one or more predetermined color developers.

8. A consumable product replacement sensing system comprising:
a mountable consumable product unit determining whether a consumable product is a new consumable product and determining a type of the consumable product; and
a consumable product replacement sensing apparatus determining whether a mounted consumable product unit is the new consumable product unit and determining the type of the mounted consumable product unit.

9. The consumable product replacement sensing system of claim 8, wherein the consumable product unit comprises:
a first determination element determining whether the mounted consumable product is the new consumable product;
a second determination element determining the type of the mounted consumable product in the consumable product replacement sensing apparatus;
a first connection terminal connected to a first end of the first determination element;
a second connection terminal connected to a first end of the second determination element; and
a third connection terminal commonly connected to second ends of the first and second determination elements.

10. The consumable product replacement sensing system of claim 9, wherein the first determination element is a first resistor having a predetermined first resistance value.

11. The consumable product replacement sensing system of claim 10, wherein the first resistor is a fusible resistor, which melts to disconnect from at least one of the first and third connection terminals when an over-current is supplied.

12. The consumable product replacement sensing system of claim 9, wherein the second determination element is a second resistor having a predetermined second resistance value, the second resistance value being higher than the first resistance value.

13. The consumable product replacement sensing system of claim 12, wherein the second resistance value varies according to a manufacture and/or type of the consumable product.

14. The consumable product replacement sensing system of claim 9, wherein the consumable product replacement sensing apparatus comprises:
fourth through sixth connection terminals electrically and respectively connected to the first through third connection terminals;
a new product determining signal generating unit generating a level of electrical potential corresponding to at least one of the first and the second determination elements connected to the consumable product replacement sensing apparatus through the fourth and fifth connection terminals to determine whether the consumable product unit is the new consumable product;
an over-current supplying unit intermitting a current-flow path continuing from the fourth connection terminal through the first determination element to the sixth connection terminal by supplying an over-current to disconnect the first determination element from the at least one of the first and third connection terminals; and
an engine control unit controlling the over-current supplying unit to disconnect the first determination element from at least one of the first and third connection terminals if the consumable product is determined to be the new consumable product by the level of electrical potential generated at the new product determining signal generating unit, the engine control unit determining the type and/or manufacturer of the consumable product by the level of electrical potential corresponding to the second determination element.

15. The consumable product replacement sensing system of claim 14, wherein:
the engine control unit determines that the consumable product is the new consumable product if the level of electrical potential outputted from the new product determining signal generating unit is a first electrical potential level corresponding to the first and second determination elements, and determines that the consumable product is a used consumable product if the level of electrical potential outputted from the new product determining signal generating unit is a second electrical potential level corresponding to the second determination element, and
the first electrical potential level is lower than a reference level, and the second electrical potential level exceeds the reference level.

16. The consumable product replacement sensing system of claim 14, further comprising:
a shared port such that the level of electrical potential to determine whether the consumable product unit is the new consumable product unit and the level of electrical potential corresponding to the second determination element are inputted from the new product determining signal generating unit to the engine control unit through the shared port.

17. The consumable product replacement sensing system of claim 14, wherein the new product determining signal generating unit comprises:
a first power source;
a third resistor having a first end connected to the first power source and a second end communicating with the engine control unit and connected to the fifth connection terminal; and
a diode disposed between the fourth and fifth connection terminals to prevent an electric current of the fourth connection terminal from flowing into the fifth connection terminal.

18. The consumable product replacement sensing system of claim 14, wherein the over-current supplying unit comprises:
a second power source; and
a switching element to connect the second power source to or to disconnect the second power source from the fifth connection terminal according to a control signal of the engine control unit.

19. The consumable product replacement sensing system of claim 8, wherein:
the consumable product comprises a cartridge containing one or more predetermined color developers,
the consumable product unit provided with the consumable product comprises a developing device that develops an image by using the one or more color developers supplied from the consumable product, and
the consumable product replacement sensing apparatus is provided in an image forming apparatus that forms the image developed by the developing device on a paper.

20. A consumable product replacement sensing method comprising:
mounting a consumable product unit in a consumable product replacement sensing apparatus;
when the consumable product unit is mounted, determining whether the consumable product is a new consumable product; and
determining whether the consumable product is a consumable product useable in the consumable product replacement sensing apparatus and/or determining a manufacturer of the consumable product.

21. The consumable product replacement sensing method of claim 20, wherein the mounting of the consumable product unit comprises:
respectively and electrically connecting first through third connection terminals provided in the consumable product unit to fourth through sixth connection terminals provided in the consumable product replacement sensing apparatus and the first connection terminal is connected to a first end of a first determination element to determine whether the consumable product is new, the second connection terminal is connected to first end of a second determination element to determine whether the consumable product is usable, and the third connection terminal is commonly connected to second ends of the first and second determination elements.

22. The consumable product replacement sensing method of claim 21, wherein the determining of whether the consumable product is the new consumable product comprises:
generating a level of electrical potential corresponding to at least one of the first and second determination elements connected to the consumable product replacement sensing apparatus through the fourth and fifth connection terminals; and
determining whether the consumable product is the new consumable product by the level of electrical potential.

23. The consumable product replacement sensing method of claim 21, wherein the determining of whether the consumable product is usable and/or of a manufacturer thereof comprises:
supplying an over-current to the first determination element to disconnect the first determination element from at least one of the first and third connection terminals when the consumable product is determined to be the new consumable product; and
determining whether the consumable product is usable and/or determining the manufacture thereof by the level of electrical potential corresponding to the second determination element.

24. The consumable product replacement sensing method of claim 22, wherein the determining of whether the consumable product is the new consumable product further comprises:
determining that the consumable product is the new consumable product if the level of electrical potential is a first electrical potential level corresponding to the first determination element; and
determining that the consumable product is a used consumable product if the level of electrical potential is a second electrical potential level corresponding to the second determination element, the first electrical potential level being lower than a reference level.

25. The consumable product replacement sensing method of claim 23, wherein the supplying of the over-current to the first determination element to disconnect the first determination element from the at least one of the first and third connection terminals comprises:
melting the first determination element, which has a predetermined first resistance value and is a fusible resistor, to disconnect the at least one of the first and third connection terminals when the over-current is supplied.

26. The consumable product replacement sensing method of claim 25, wherein the second determination element has a predetermined second resistance value, which is higher than the first resistance value.

27. The consumable product replacement sensing method of claim 26, further comprising:
varying the second resistance value according to the type and/or manufacturer of the consumable product.

28. The consumable product replacement sensing method of claim 20, wherein
the consumable product comprises a cartridge containing one or more predetermined color developers;
the consumable product unit provided with the consumable product comprises a developing device that develops an image by using the one or more color developers supplied from the consumable product; and
the consumable product replacement sensing apparatus is provided in an image forming apparatus that forms the image developed by the developing device on a paper.

29. The consumable product replacement sensing method of claim 22, wherein the generating of the level of electrical potential comprises:
outputting through a shared port the level of electrical potential to determine whether the consumable product is the new consumable product and the level of electrical potential corresponding to the second determination element.

30. A sensing apparatus for recognizing a consumable unit, the consumable unit including a consumable product, first through third connection terminals each connected to the sensing apparatus, and having a first resistive element having a first resistance value across the first and third terminals of the consumable unit and a second resistive element having a second resistance value across the second and third terminals of the consumable unit, the sensing apparatus comprising:
a signal generating portion to generate a signal corresponding to a parallel composite resistance value of the first and second resistive elements of the consumable unit connected to the signal generation portion;
a disconnecting portion to disconnect a current path from the first connection terminal of the consumable unit to the third connection terminal of the consumable unit; and
a controller to control the disconnecting portion to disconnect the current path and to compare a level of the signal that is generated from the signal generating portion with predetermined standard levels to determine whether the consumable unit is usable in a system and/or to determine a manufacturer of the consumable unit using the sensing apparatus.

31. A sensing apparatus for recognizing a consumable unit including parallel resistive elements, comprising:
a signal generating portion to generate a signal corresponding to a parallel composite resistance value of the consumable unit connected to the signal generation portion;
a disconnecting portion to selectively disconnect a respective one of the parallel resistive elements of the consumable unit; and
a controller to control the disconnecting portion to disconnect the respective one of the parallel resistive elements and to compare a level of the signal that is generated from the signal generating portion, after the respective one of the parallel resistive elements is disconnected, with predetermined standard levels to determine whether the consumable unit is usable in a system and/or to determine a manufacturer of the consumable unit using the sensing apparatus.

32. A method of recognizing whether a consumable unit is replaced, the consumable unit including a consumable product, first through third connection terminals each connected to a sensing apparatus, and having a first resistive element having a first resistance value across the first and third terminals of the consumable unit and a second resistive element having a second resistance value across the second and third terminals of the consumable unit, the method comprising:
electrically connecting fourth through sixth connection terminals of the sensing apparatus, respectively, to the first through third connection terminals of the consumable unit;
generating a signal corresponding to a parallel composite resistance value of the first and second resistive elements of the consumable unit through the first and second terminals;
disconnecting a current path from the first connection terminal of the consumable unit to the third connection terminal of the consumable unit, if the consumable unit is determined to be new based on a level of the generated signal corresponding to a reference level for which the current path is not disconnected; and
after the disconnecting of the current path, determining whether the consumable unit is useable in a system and/or determining a manufacturer of the consumable unit by measuring the generated signal level.

33. A method of recognizing whether a consumable unit is replaced, the consumable unit including a consumable product, first through third connection terminals each connected to a sensing apparatus, and having a first resistive element having a first resistance value across the first and third terminals of the consumable unit and a second resistive element having a second resistance value across the second and third terminals of the consumable unit, the method comprising:
generating a signal corresponding to a parallel composite resistance value of the first and second resistive elements of the consumable unit;
disconnecting a current path from the first connection terminal of the consumable unit to the third connection terminal of the consumable unit, if a level of the generated signal is less than a reference level; and
after the disconnecting of the current path, comparing the level of the generated signal with predetermined standard levels to determine whether the consumable unit is usable in a system using the sensing apparatus and/or to determine a manufacturer of the consumable unit.

34. A method of sensing a consumable unit including parallel resistive elements, comprising:
generating a signal corresponding to a parallel composite resistance value of the first and second resistive elements of the consumable unit;
selectively disconnecting a respective one of the parallel resistive elements of the consumable unit; and
after the selectively disconnection of the respective one of the parallel resistive elements, comparing a level of the generated signal with predetermined standard levels to determine whether the consumable unit is usable in a system and/or to determine a manufacturer of the consumable unit.

35. A sensing system, comprising:
a consumable unit to be replaced, the consumable unit comprising:
a consumable product, and
first through third connection terminals having a fuse element with a first resistance value across the first and third terminals of the consumable unit and a second resistive element with a second resistance value across the second and third terminals of the consumable unit;
a connector portion having fourth through sixth connection terminals electrically connected to the first through third connection terminals, respectively;
a signal generating portion generating a signal corresponding to an effective resistance value of the consumable product unit connected to the signal generation portion through the fourth and fifth connection terminals of the connector portion;
a fuse disconnecting portion intermitting a current-flowing path continuing from the fourth connection terminal of the connector portion through the fuse element to the sixth connection terminal of the connector portion; and
a determining portion controlling the fuse disconnecting portion to disconnect the fuse element if the consumable product of the consumable product unit is determined to be a new consumable product unit by the signal generated from the signal generating portion, and determining whether the consumable product unit is useable in a system or determining a manufacturer of the consumable unit by the generated signal, corresponding to a resistance value of the second resistive element, which is subsequently generated from signal generating portion.

36. A consumable product unit comprising:
a new product determining element determining whether a consumable product is a new consumable product;
a type determining element determining a type and/or a manufacturer of the consumable product;
a first connection terminal connected to a first end of the new product determining element;
a second connection terminal connected to a first end of the second determining element; and
a third connection terminal commonly connected to second ends of the new and second determining elements.

37. A consumable product replacement sensing method comprising:
mounting a consumable product unit in a consumable product sensing apparatus;
determining whether the consumable product is a new consumable product;
determining whether the consumable product is a consumable product useable in the consumable product replacement sensing apparatus and/or determining a manufacturer of the consumable product; and
outputting status information of the consumable product from the determining operations.

38. A sensing system, comprising:
a consumable unit including parallel resistive elements; and
a sensing apparatus to recognize the consumable unit comprising:
a signal generating portion to generate a signal corresponding to a parallel composite resistance value of the consumable unit connected to the signal generation portion,
a disconnecting portion to selectively and permanently disconnect a respective one of the parallel resistive elements of the consumable unit, and
a controller to control the disconnecting portion to disconnect the respective one of the parallel resistive elements and to compare a level of the signal that is generated from the signal generating portion, after the respective one of the parallel resistive elements is disconnected, with predetermined standard levels to determine whether the consumable unit is usable in a system and/or to determine a manufacturer of the consumable unit using the sensing apparatus.
